(19) United States
(12) Patent Application Publication
(10) Pub. No.: US 2020/0402182 A1
(43) Pub. Date: Dec. 24, 2020

(54) SYSTEMS AND METHODS FOR PROGRESSIVE FEATURE ACTIVATION

(71) Applicant: Facebook, Inc., Menlo Park, CA (US)

(72) Inventors: Athena Kardehi Moghaddam, Fremont, CA (US); Daniel Dinu, Sunnyvale, CA (US)

(21) Appl. No.: 15/981,848

(22) Filed: May 16, 2018

(51) Int. Cl. G06Q 50/00; G06F 11/34; G06F 17/30

(52) U.S. Cl. CPC G06Q 50/01; G06F 17/3089; G06F 11/3438

(57) ABSTRACT

Systems, methods, and non-transitory computer readable media are configured to determine a skill level of a user. One or more features can be selected based on the skill level. Subsequently, one or more of the features can be activated for a page on a social networking system.

### FIELD OF THE INVENTION

The present technology relates to computerized social networking systems. More particularly, the present technology relates to techniques for progressively activating features within computerized social networking systems.

### BACKGROUND

A social networking system can be used for a wide variety of purposes. For example, a business or other entity can use a page on the social networking system to connect with users of the social networking system. The page can have one or more administrators. The social networking system can provide the administrators with a number of features. The features can allow the administrators to perform various actions for the page.

### SUMMARY

Various embodiments of the present disclosure can include systems, methods, and non-transitory computer readable media configured to determine a skill level of a user. One or more features can be selected based on the skill level. Subsequently, one or more of the features can be activated for a page on a social networking system.

In an embodiment, the one or more features can comprise at least one of a feature which allows users to be invited to the page on the social networking system, a feature which allows a post to be added to the page on the social networking system, or a feature which allows a button to be added to the page on the social networking system.

In an embodiment, the one or more features can relate to administration of the page on the social networking system.

In an embodiment, a request for display of the page on the social networking system can be received.

In an embodiment, the user can be determined to have completed one or more factors.

In an embodiment, the one or more factors can comprise at least one of the page on the social networking system amassing a selected number of fans, a picture being added to the page on the social networking system, or a post being made to the page on the social networking system.

In an embodiment, a further skill level can be associated with the user.

In an embodiment, one or more further features can be selected based on the further skill level.

In an embodiment, a level elevation experience can be provided to the user.

In an embodiment, a graduation experience can be provided to the user.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including an example feature progression module, according to an embodiment of the present disclosure.

FIG. 2 illustrates an example feature module, according to an embodiment of the present disclosure.

FIG. 3 illustrates an example factor module, according to an embodiment of the present disclosure.

FIGS. 4A-4B illustrate example scenarios, according to an embodiment of the present disclosure.

FIG. 5 illustrates an example process, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

Approaches for Progressive Feature Activation

A social networking system can be used for a wide variety of purposes. For example, a business or other entity can use a page on the social networking system to connect with users of the social networking system. The page can have one or more administrators. The social networking system can provide the administrators with a number of features. The features can allow the administrators to perform various actions for the page.

The social networking system can make a wide variety of these features available to the administrators of a page. As an example, the social networking system can provide a feature which allows text posts to be made to the page. As another example, the social networking system can provide a feature which allows friends to be invited to the page. As a further example, the social networking system can provide a feature which allows the page to be promoted. As an additional example, the social networking system can provide a feature which allows a website to be associated with the page. Moreover, improvements to the social networking system can cause new features to be made available. The wide variety of features can empower the administrators to use the page in an effective manner. However, the administrators can find themselves overwhelmed by the wide variety of features.

Due to these or other concerns, the aforementioned and other conventional approaches specifically arising in the realm of computer technology can be disadvantageous or problematic. Therefore, an improved approach can be beneficial for addressing or alleviating various drawbacks associated with conventional approaches. Based on computer technology, the disclosed technology can progressively activate features provided by a social networking system. In some embodiments, the social networking system can select and activate features for a user based on a skill level of the user. The user can be an administrator of a page (or other location) on the social networking system. The features can relate to administration of the page. The social networking system can inform the user of factors which the user can satisfy or complete in order to advance from the skill level to a new skill level. The factors can be actions or achievements which relate to administration of the page. As just one example, a factor can be inviting a specified number of friends to the page. The user can use the features to complete the factors. In response to a completion of the factors, the social networking system can perform various operations. The operations can include associating the new skill level with the user and congratulating the user. The operations can also include selecting and activating further features for the user based on the new skill level of the user. Moreover, the operations can include informing the user of further factors which the user can complete in order to advance to another skill level. In this way, the user can progress to additional skill levels and receive access to additional features. More details regarding the discussed technology are provided herein.

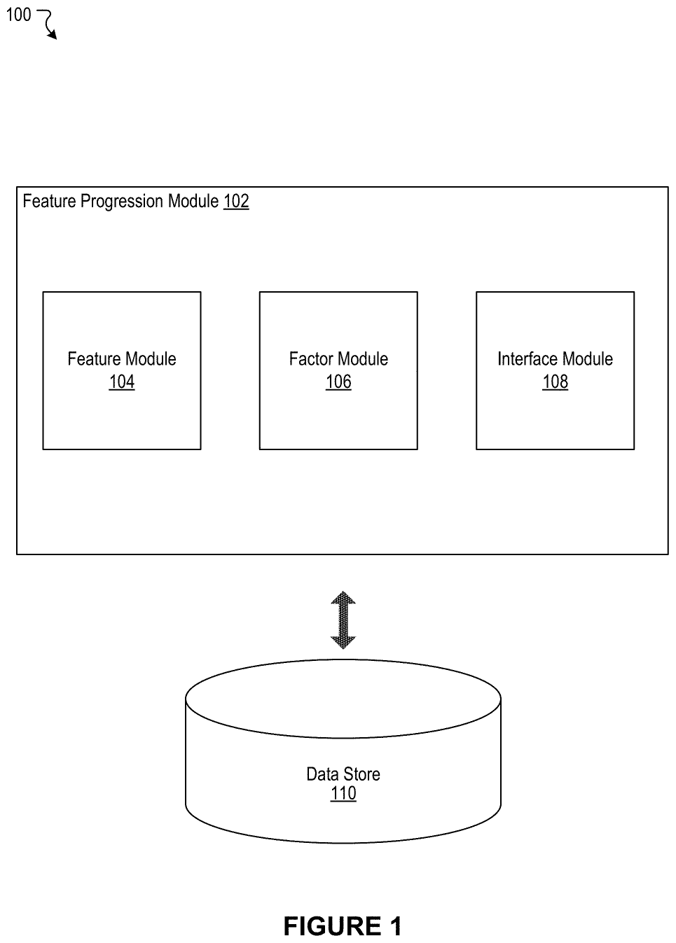

FIG. 1 illustrates an example system 100 including an example feature progression module 102, according to an embodiment of the present disclosure. The feature progression module 102 can progressively activate features provided by a social networking system. The social networking system can select and activate features for a user based on a skill level of the user. The user can be an administrator of a page or other location on the social networking system. A page can be a dedicated presence or location of an entity on the social networking system. As examples, the entity can be a business, a company, a brand, a service, a product, a public figure, or an individual. While a page is referenced in examples discussed herein, the present disclosure applies to other locations, channels, or resources of a social networking system. As shown in the example of FIG. 1, the feature progression module 102 can include a feature module 104, a factor module 106, and an interface module 108. In some instances, the example system 100 can include at least one data store 110. The components (e.g., modules, elements, etc.) shown in this figure and all figures herein are exemplary only, and other implementations can include additional, fewer, integrated, or different components. Some components may not be shown so as not to obscure relevant details. In some embodiments, the feature progression module 102 can be implemented in a system, such as a social networking system. While the disclosed technology may be described herein in connection with a social networking system for illustrative purposes, the disclosed technology can be implemented in any other type of system or environment.

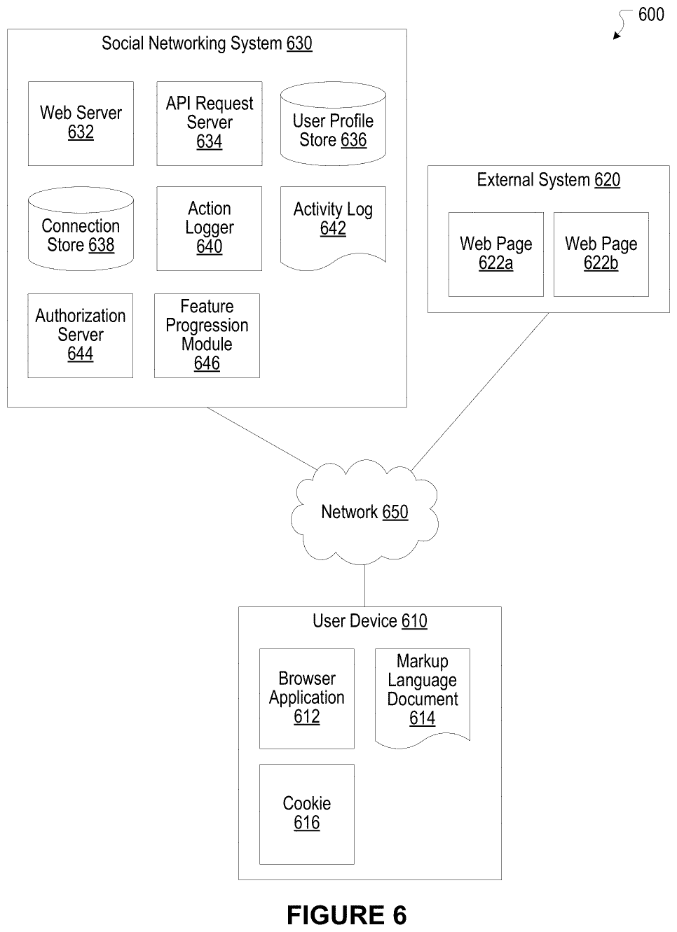

In some embodiments, the feature progression module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the feature progression module 102 can be implemented, in part or in whole, as software running on one or more computing devices or systems. For example, the feature progression module 102 or at least a portion thereof can be implemented using one or more computing devices or systems that include one or more servers, such as network servers or cloud servers. In another example, the feature progression module 102 or at least a portion thereof can be implemented as or within an application (e.g., app), a program, an applet, or an operating system, etc., running on a user computing device or a client computing system, such as a user device 610 of FIG. 6. In some instances, the feature progression module 102 can, in part or in whole, be implemented within or configured to operate in conjunction with a system (or service), such as a social networking system 630 of FIG. 6. The application incorporating or implementing instructions for performing functionality of the feature progression module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that there can be many variations or other possibilities.

The feature progression module 102 can be configured to communicate and/or operate with the at least one data store 110, as shown in the example system 100. The at least one data store 110 can be configured to store and maintain various types of data. For example, the data store 110 can store information used or generated by the feature progression module 102. The information used or generated by the feature progression module 102 can include, for example, feature data, factor data, skill level data, and experience data. In some implementations, the at least one data store 110 can store information associated with the social networking system (e.g., the social networking system 630 of FIG. 6). The information associated with the social networking system can include data about users, social connections, social interactions, locations, geo-fenced areas, maps, places, events, pages, groups, posts, communications, content, feeds, account settings, privacy settings, a social graph, and various other types of data. In some implementations, the at least one data store 110 can store information associated with users, such as user identifiers, user information, profile information, user specified settings, content produced or posted by users, and various other types of user data.

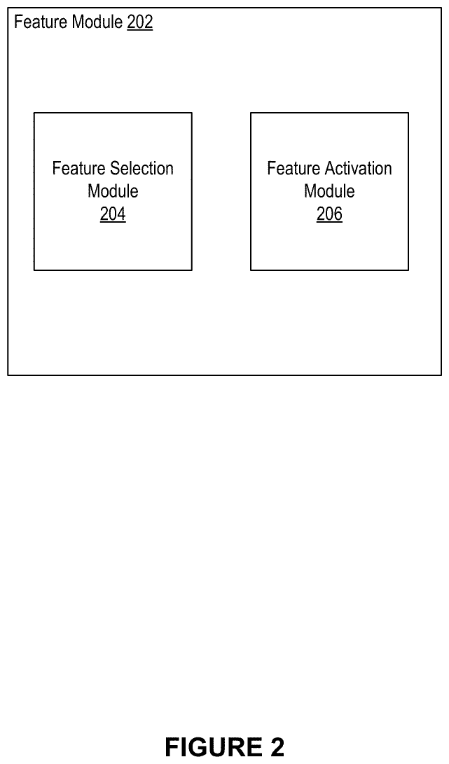

The feature module 104 can select features based on a skill level of a user. As an example, the selected features can include features for administration of a page on the social networking system. The feature module 104 can also activate the selected features. The activation can include presenting the selected features to the user through a user interface of a user computing device associated with the user. Additional details regarding the feature module 104 are provided below with reference to FIG. 2.

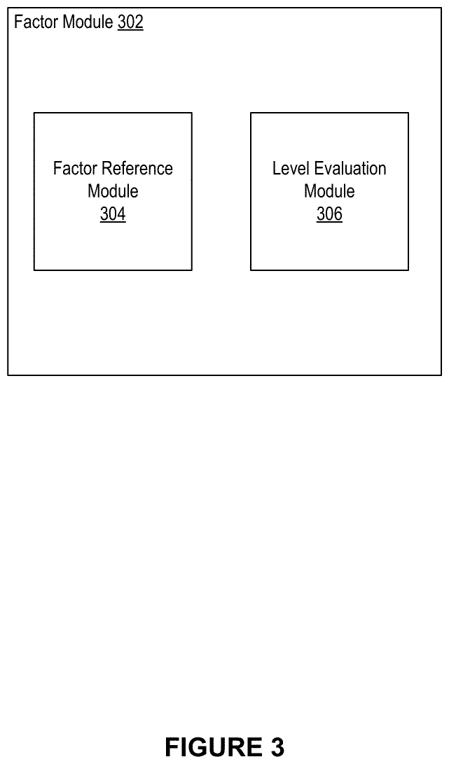

The factor module 106 can ascertain factors which a user is to complete in order to advance from a current skill level. As an example, the factors can include actions or achievements relating to administration of a page on the social networking system. The factor module 106 can also determine whether or not the user has completed all of the factors. Where the factor module determines that the user has completed all of the factors, the factor module 106 can perform operations including setting an indication that the user has advanced. Additional details regarding the factor module 106 are provided below with reference to FIG. 3.

The interface module 108 can receive a request to display a page on the social networking system. The request can be provided by a user who is an administrator of the page. The request can be received through an interface provided by a user computing device. A skill level can be associated with the user. As discussed in more detail herein, the interface module 108 can use the feature module 104 to select features for the user based on the skill level of the user. The features can relate to administration of the page. The interface module 108 can further use the feature module 104 to activate the features. The activation of the features can include presenting the features to the user using the interface. The user can employ the interface to use one or more of the features. In using the features, the user can work towards completing one or more factors which can allow the user to advance from the skill level. As examples, the factors can be actions and achievements which relate to administration of the page. As one illustration, one of the factors can be the page amassing a selected number of fans. A fan can be a user who has liked the page within the social networking system. As another illustration, one of the factors can be adding a button to the page. The interface module 108 can inform the user of these factors. As the user uses the features, the interface module 108 can use the factor module 106 to keep track of those of the factors which the user has completed. The factor module 106 can recognize completion of factors, as discussed in more detail herein.

The interface module 108 can use the factor module 106 to perform one or more operations which relate to having the user advance from the skill level. Advancing from the skill level can cause a new skill level to be associated with the user. As examples, the operations can include providing a level elevation experience to the user. In some embodiments, the level elevation experience can include congratulating the user and informing the user of one or more factors which can allow the user to advance to yet another skill level. The interface module 108 can use the feature module 104 to select features for the user based on the new skill level. The interface module 108 can use the feature module 104 to activate those features for the user. In some embodiments, the level elevation experience can include providing the user with one or more new user experiences (NUXs). The new user experiences can include introducing the user to one or more available features. The new user experiences can also include educating the user regarding usage of one or more available features. Many variations are possible.

By repeated performance of the discussed operations, the user can advance to higher skill levels and experience activation of further features. In some embodiments, the repeated performance can lead to a graduation of the user that represents completion of a certain skill level. Under this circumstance, the interface module 108 can use the factor module 106 to perform one or more operations which relate to the graduation. Among these operations can be providing a graduation experience to the user. The graduation experience can include using the interface to congratulate the user.

FIG. 2 illustrates an example feature module 202, according to an embodiment of the present disclosure. In some embodiments, the feature module 104 of FIG. 1 can be implemented as the example feature module 202. As shown in FIG. 2, the feature module 202 can include a feature selection module 204 and a feature activation module 206.

The feature selection module 204 can select features for a user based on a skill level of the user. The feature selection module 204 can select the features from a set of available features. In some embodiments, the set of available features can include features for administration of a page on the social networking system.

As an example, the features for administration can include a feature which allows a button to be added to the page. As another example, the features for administration can include a feature which allows users of the social networking system to be invited to the page. As a further example, the features for administration can include a feature which allows a post to be added to the page. In some embodiments, the set of available features can include multiple versions of features. For example, the set of available features can include a non-simplified version and a simplified version of a given feature. As an illustration, the set of available features can include a non-simplified version and a simplified version of the feature which allows a post to be added. The non-simplified version can include a field for making a text post, and icons for making various non-text posts. The simplified version can also include a field for making a text post. However, instead of icons for making various non-text posts, the simplified version can include a toolbar for making various non-text posts.

In some embodiments, the features of the set can be ordered into a sequence. In these embodiments, each feature of the set can have a corresponding number which corresponds to a location of that feature in the sequence. As an example, where there are n features in the set, each feature of the set can have a corresponding number between 0 and n. As one example, the features of the set can be ordered according to difficulty of using the features, where a given feature of the set can have a location in the sequence which reflects a difficulty of using the feature. In some embodiments, a difficulty of using a given feature can be ascertained through user testing.

For the embodiments where the features of the set are ordered into a sequence, the feature selection module 204 can use a function when selecting the features for the user. The function can take as an input the skill level of the user. The function can return, as an output, a value. The feature selection module 204 can select for the user those features of the sequence whose corresponding numbers fall in a range. The range can start with a beginning of the sequence and end with the returned value. As an illustration, where the function returns a value r, and each feature of the set has a corresponding number in the range of 0-n, the feature selection module 204 can select those features whose corresponding numbers fall within 0-r. In some embodiments, user testing can be used in configuring a mapping between inputs and outputs performed by the function. In these embodiments, the function can be configured such that use of the function causes the features selected for a given skill level to be features found to be appropriate for that skill level by the user testing.

In some embodiments, a resource, such as a lookup table, can list various skill levels. For each of the skill levels, the resource can identify one or more features of the set. For these embodiments, the feature selection module 204 can select for the user those features that the resource lists for the skill level of the user. In some embodiments, user testing can be used in populating the resource. In particular, the resource can be populated such that the features identified for a given skill level are features found to be appropriate for the skill level by the user testing.

The feature activation module 206 can activate one or more features for a user. The feature activation module 206 can use the feature selection module 204 to select features for the user. The feature activation module 206 can subsequently activate the selected features. In particular, the feature activation module 206 can place each of the selected features at a location on a user interface which is presented to the user. In some embodiments, a resource, such as a lookup table, can specify for each feature of the set a corresponding user interface location for the feature. In these embodiments, the feature activation module 206 can perform the placement of the selected features at user interface locations specified by the resource. As an illustration, the resource can specify that the feature which allows users to be invited to a page be placed at a particular horizontally-centered user interface location. Many variations are possible.

FIG. 3 illustrates an example factor module 302, according to an embodiment of the present disclosure. In some embodiments, the factor module 106 of FIG. 1 can be implemented as the example factor module 302. As shown in FIG. 3, the factor module 302 can include a factor reference module 304 and a level evaluation module 306.

The factor reference module 304 can access a skill level for a given user. The factor reference module 304 can also access a first resource, such as a lookup table. The first resource can list various skill levels. For each of the listed skill levels, the first resource can identify one or more factors which are to be completed in order for advancement from the listed skill level. In some embodiments, the factors can include actions or achievements relating to administration of a page on the social networking system. For each of the listed skill levels, the first resource can further identify an event which follows the advancement. As one example, the event can be an elevation to an indicated higher skill level. As another example, the event can be a graduation. In some embodiments, the graduation can signify a completion of all listed skill levels.

As an illustration, the skill levels listed by the first resource can include a neophyte skill level and an intermediate skill level. For the neophyte skill level, the first resource can identify four factors which are to be completed by an administrator of a page for advancement from the neophyte skill level. Also, the first resource can identify elevation to the intermediate skill level as an event which follows the advancement. A first of the four factors can indicate that ten fans are to be amassed by the page. A second of the four factors can indicate that a profile picture is to be added to the page. A third of the four factors can indicate that a cover photo is to be added to the page. A fourth of the four factors can indicate that a post is to be made to the page. Many variations are possible.

The factor reference module 304 can use the first resource to determine those factors which are to be completed for advancement of the user. The factor reference module 304 can further use the first resource to determine an event which follows the advancement.

Further, the factor reference module 304 can access a factor, and a second resource, such as a lookup table. The second resource can list various users. For each of the listed users, the second resource can identify those factors which the listed user has completed. The factor reference module 304 can use the second resource to determine whether or not a given user has completed the factor. Moreover, the factor reference module 304 can detect when one of the listed users has completed a factor. When the factor reference module 304 detects that one of the listed users has completed a factor, the factor reference module 304 can access the second resource. In particular, the factor reference module 304 can set the second resource to identify that the one of the listed users has completed the factor.

The level evaluation module 306 access a third resource, such as a lookup table. The third resource can list various users. For each of the listed users, the third resource can identify a current skill level for the listed user. The level evaluation module 306 can use the third resource to determine a current skill level for a given user. The level evaluation module 306 can use the factor reference module 304 with the current skill level. As a result, the level evaluation module 306 can ascertain those factors which are to be completed in order for advancement from the current skill level. Further as a result, the level evaluation module 306 can ascertain an event which follows the advancement. For each of the factors which are to be completed, the level evaluation module 306 can use the factor reference module 304 with respect to the user. In particular, the level evaluation module 306 can use the factor reference module 304 to determine whether or not the user has completed the factor. Accordingly, the level evaluation module 306 can determine whether or not the user has completed all of the factors which are to be completed in order for advancement from the current skill level. In some circumstances, the level evaluation module 306 can determine that the user has completed all of the factors. In these circumstances, the level evaluation module 306 can act based on the ascertained event which follows the advancement.

Where the event is elevation to an indicated higher skill level, the level evaluation module 306 can perform a number of operations. The operations can include setting the third resource to identify the higher skill level as the current skill level for the user. Also among these operations can be using the factor reference module 304 with the higher skill level. As a result, the level evaluation module 306 can ascertain those factors which are to be completed in order for advancement from the higher skill level. These operations also can include using the feature module 202 with the higher skill level. As a result, the level evaluation module 306 can ascertain those features which are selected for the higher skill level. In some embodiments, the operations also can include providing a level elevation experience to the user. In these embodiments, the level evaluation module 306 can use an interface presented through a user computing device to provide various output to the user. As one example, the output can congratulate the user for being elevated to the higher skill level. As another example, the output can inform the user of the factors which are to be completed in order for advancement from the higher skill level. As such, the user can learn which factors are to be completed in order to achieve further advancement. As an additional example, the output can inform the user of the features which are selected for the higher skill level. As such, the user can know that these features are available for use. In some embodiments, the output can inform the user of an additional skill level or a graduation which can follow the advancement. Many variations are possible.

In some embodiments, where the event is a graduation, the level evaluation module 306 can provide a graduation experience to the user. In these embodiments, the level evaluation module 306 can use the interface provided by the user computing device to commend the user for graduating. Moreover, in some embodiments the level evaluation module 306 can add to the third resource or another a resource (such as another lookup table) an indication that the user has graduated. Further still, in some embodiments, when a user newly creates a page on the social networking system, the evaluation module 308 can set the third resource to identify an initial skill level as a current skill level for that user. As an illustration, the initial skill level can be a neophyte skill level. While the examples discussed herein reference various resources, the present disclosure includes variations in which the resources are integrated into one resource or variations in which any suitable number of different resources are utilized. There can be many variations or other possibilities.

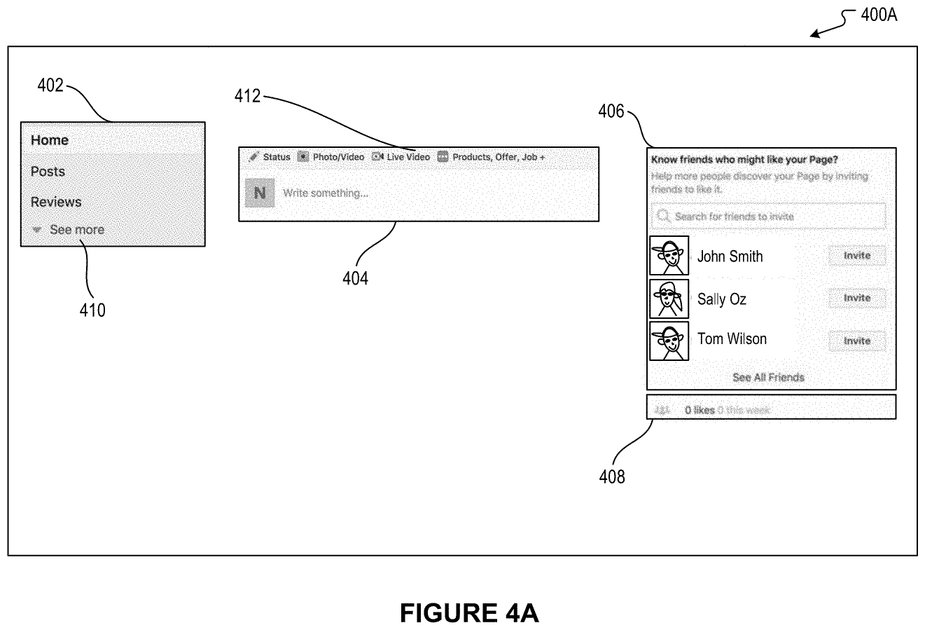

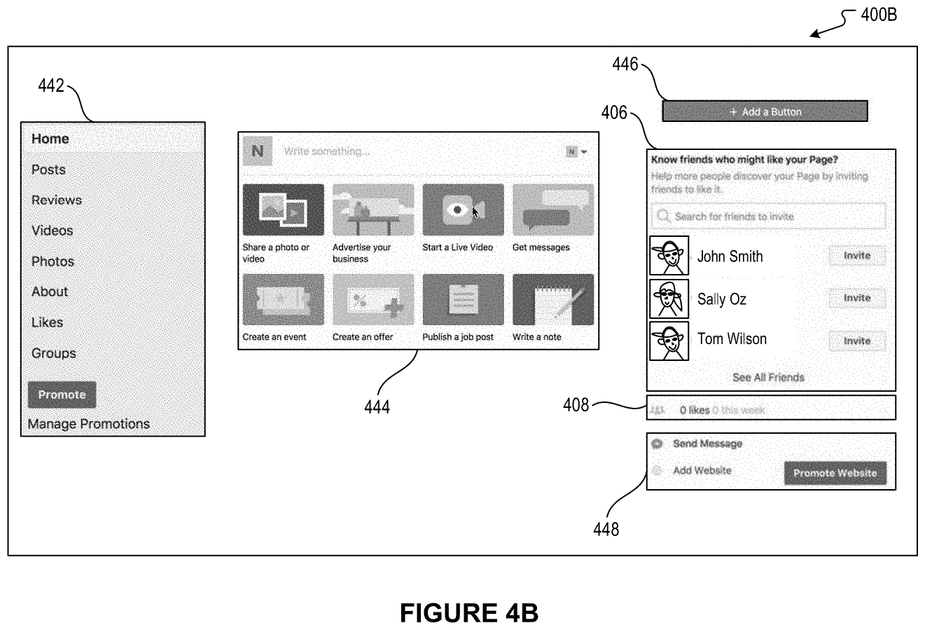

FIGS. 4A and 4B illustrate example scenarios supported by the feature progression module 102, according to an embodiment of the present disclosure. Depicted in FIG. 4A is an interface 400A. Depicted in FIG. 4B is an interface 400B. Each of the interface 400A and the interface 400B can be presented on the display of a computing device being operated by a user. Further, each of the interface 400A and the interface 400B can be provided through an application (e.g., dedicated software application, web browser, etc.) running on the computing device. At a first point in time, the user can use the computing device to request display of a page on a social networking system. The user can be an administrator of the page. In response to the request, the feature progression module 102 can display the interface 400A to the user. The interface 400A can include a feature 402, a feature 404, a feature 406, and a feature 408. The feature progression module 102 can select these features for the user based on a current skill level of the user. The features can relate to administration of the page. The feature 402 can list available actions including viewing posts of the page and viewing reviews for the page. The feature 402 can include a “see more” pulldown 410. By activating the pulldown 410, the user can perform further actions which relate to administration of the page. The further actions can include promoting the page and accessing job opportunities offered by the page. The feature 404 can allow the user to make text posts for the page. Also, by using a toolbar 412, the user can make various non-text posts for the page. The feature 406 can allow the user to invite friends of the user within the social networking system to the page. The feature 408 can allow the user to receive information about likes which the page has received.

According to the example scenario, the feature progression module 102 can inform the user that, by completing three specified factors, the user can advance from the current skill level. In a different example, a different number of factors can be specified. In the example shown, a first of the three factors can be making five posts; a second of the three factors can be inviting two friends to the page; and a third of the three factors can be attracting twelve likes to the page. The user can use one or more of the feature 402, the feature 404, the feature 406, and the feature 408 to work towards completing the specified factors. As a result, by a second point in time the user can complete the factors. The feature progression module 102 can recognize that the user has completed the factors. Subsequently, the feature progression module 102 can perform one or more operations which relate to having the user advance from the current skill level. According to the example scenario, the operations can include causing a new skill level to be associated with the user, and providing congratulations to the user. The operations can further include selecting and activating features for the user based on the new skill level. The operations can also include informing the user of one or more factors which can allow the user to further advance to a subsequent skill level.

The user can use the computing device to again request display of the page. As the new skill level has been associated with the user, the feature progression module 102 can display the interface 400B to the user. The interface 400B can include the features which have been selected for the user based on the new skill level. As such, the interface 400B can, like the interface 400A, include the feature 406 and the feature 408. Further as such, the interface 400B can, unlike the interface 400A, include a feature 442, a feature 444, a feature 446, and a feature 448. As with the other features, the feature 442, the feature 444, the feature 446, and the feature 448 can relate to administration of the page. In particular, the feature 442 can be a non-simplified version of the feature 402. Unlike the feature 402, the feature 442 additionally lists various available actions which are not listed by the feature 402. Also, the feature 442 does not include the pulldown 410. Among the actions which are additionally listed by the feature 442 are accessing photos of the page and accessing videos of the page. Further, the feature 444 can be a non-simplified version of the feature 404. Unlike the feature 404, the feature 444 includes icons for making various non-text posts. Also, unlike the feature 404, the feature 444 does not include the toolbar 412. Like the feature 404, the feature 444 can allow the user to make text posts. The feature 446 can allow the user to add a button to the page. Further, the feature 448 can allow the user to perform operations including associating a website with the page and sending a message.

The user can complete the one or more factors which allow the user to further advance to the subsequent skill level. The user can receive activation of features which correspond to the subsequent skill level. As discussed herein, the user can advance to additional skill levels and receive activation of additional features. Moreover, as also discussed herein, the user can experience a graduation. For example, the user can experience the graduation after completion of all available skill levels. There can be many variations or other possibilities.

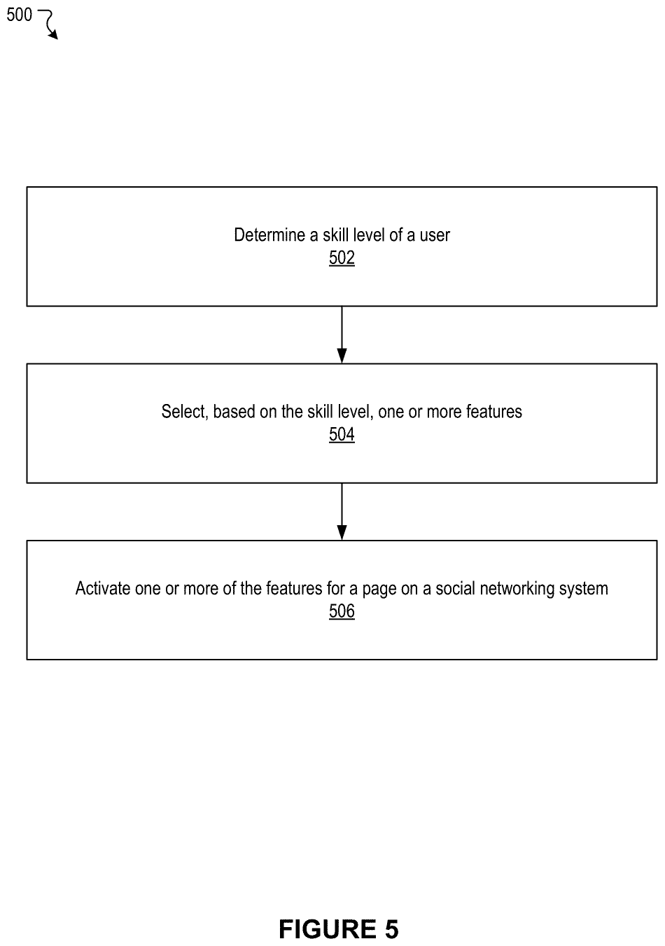

FIG. 5 illustrates an example process 500, according to various embodiments of the present disclosure. It should be appreciated that there can be additional, fewer, or alternative steps performed in similar or alternative orders, or in parallel, within the scope of the various embodiments discussed herein unless otherwise stated.

At block 502, the example process 500 can determine a skill level of a user. At block 504, the process can select, based on the skill level, one or more features. Then, at block 506, the process can activate one or more of the features for a page on a social networking system.

It is contemplated that there can be many other uses, applications, and/or variations associated with the various embodiments of the present disclosure. For example, in some cases, user can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

Social Networking System—Example Implementation

FIG. 6 illustrates a network diagram of an example system 600 that can be utilized in various scenarios, in accordance with an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices (or systems) that can receive input from a user and transmit and receive data via the network 650. In one embodiment, the user device 610 is a conventional computer system executing, for example, a Microsoft Windows compatible operating system (OS), macOS, and/or a Linux distribution. In another embodiment, the user device 610 can be a computing device or a device having computer functionality, such as a smart-phone, a tablet, a personal digital assistant (PDA), a mobile telephone, a laptop computer, a wearable device (e.g., a pair of glasses, a watch, a bracelet, etc.), a camera, an appliance, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the Silverlight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content. As discussed previously, it should be appreciated that there can be many variations or other possibilities.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects an other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music, or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list.” External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a feature progression module 646. The feature progression module 646 can, for example, be implemented as the feature progression module 102 of FIG. 1. In some embodiments, some or all of the functionality and modules of the feature progression module 646 (e.g., sub modules of the feature progression module 102) instead can be implemented in the user device 610.

Hardware Implementation

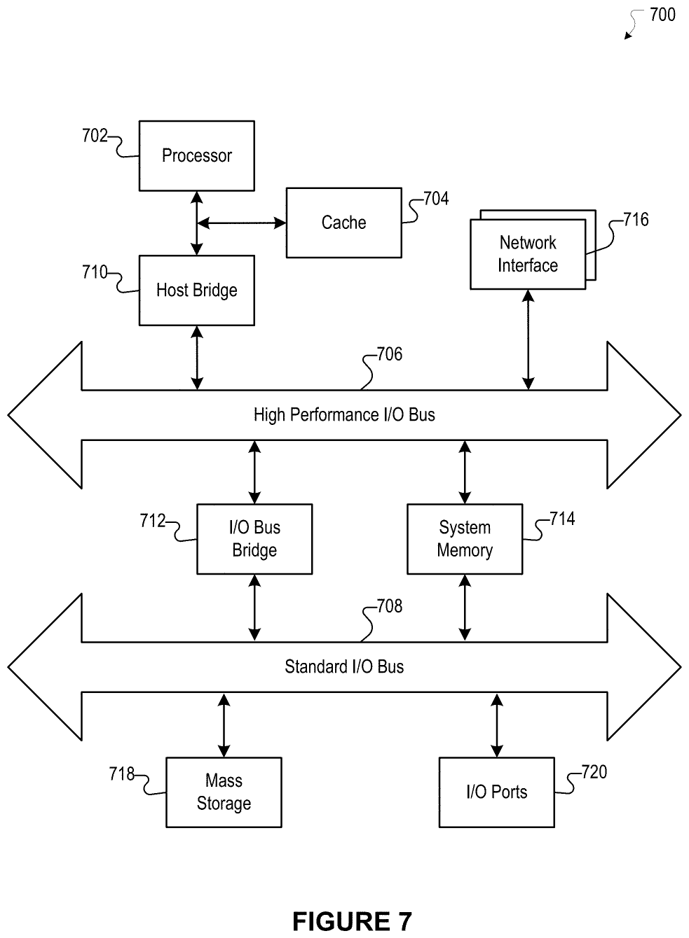

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module,” with processor 702 being referred to as the “processor core.” Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs.” For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment,” “an embodiment,” “other embodiments,” “one series of embodiments,” “some embodiments,” “various embodiments,” or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
determining, by a computing system, a skill level of a user;
selecting, by the computing system, based on the skill level, one or more features;
activating, by the computing system, the one or more features for presentation on a user interface associated with a page on a networking system;
determining, by the computing system, a further skill level associated with the user; and
selecting, by the computing system, based on the further skill level, one or more further features for presentation through the user interface.

2. The computer-implemented method of claim 1, wherein the one or more features comprise at least one of a feature which allows users to be invited to the page on the networking system, a feature which allows a post to be added to the page on the networking system, or a feature which allows a button to be added to the page on the networking system.

3. The computer-implemented method of claim 1, wherein the one or more features relate to administration of the page on the networking system.

4. The computer-implemented method of claim 1, further comprising:
receiving, by the computing system, a request for display of the page on the networking system.

5. The computer-implemented method of claim 1, further comprising:
determining, by the computing system, the user to have completed one or more factors.

6. The computer-implemented method of claim 5, wherein the one or more factors comprise at least one of the page on the networking system amassing a selected number of fans, a picture being added to the page on the networking system, or a post being made to the page on the social networking system.

7. (canceled)

8. (canceled)

9. The computer-implemented method of claim 5, further comprising:
providing, by the computing system, a level elevation experience to the user, wherein providing the level elevation experience comprises providing the user with the one or more further features.

10. The computer-implemented method of claim 5, further comprising:
providing, by the computing system, a graduation experience to the user, wherein providing the graduation experience comprises congratulating the user.

11. A system comprising:
at least one processor; and
a memory storing instructions that, when executed by the at least one processor, cause the system to perform:
determining a skill level of a user;
selecting, based on the skill level, one or more features;
activating the one or more features for presentation on a user interface associated with a page on a networking system;
determining a further skill level associated with the user; and
selecting based on the further skill level, one or more further features for presentation through the user interface.

12. The system of claim 11, wherein the instructions, when executed by the at least one processor, further cause the system to perform:
receiving a request for display of the page on the networking system.

13. The system of claim 11, wherein the instructions, when executed by the at least one processor, further cause the system to perform:
determining the user to have completed one or more factors.

14. (canceled)

15. (canceled)

16. A non-transitory computer-readable storage medium including instructions that, when executed by at least one processor of a computing system, cause the computing system to perform a method comprising:
determining a skill level of a user;
selecting, based on the skill level, one or more features;
activating the one or more features for presentation on a user interface associated with a page on a networking system;
determining a further skill level associated with the user; and
selecting based on the further skill level, one or more further features for presentation through the user interface.

17. The non-transitory computer-readable storage medium of claim 16, wherein the instructions, when executed by the at least one processor of the computing system, further cause the computing system to perform:
receiving a request for display of the page on the networking system.

18. The non-transitory computer-readable storage medium of claim 16, wherein the instructions, when executed by the at least one processor of the computing system, further cause the computing system to perform:
determining the user to have completed one or more factors.

19. (canceled)

20. (canceled)

21. The system of claim 11, wherein the one or more features comprise at least one of a feature which allows users to be invited to the page on the networking system, a feature which allows a post to be added to the page on the networking system, or a feature which allows a button to be added to the page on the networking system.

22. The system of claim 11, wherein the one or more features relate to administration of the page on the networking system.

23. The system of claim 13, wherein the one or more factors comprise at least one of the page on the networking system amassing a selected number of fans, a picture being added to the page on the networking system, or a post being made to the page on the networking system.

24. The non-transitory computer-readable storage medium of claim 16, wherein the one or more features comprise at least one of a feature which allows users to be invited to the page on the networking system, a feature which allows a post to be added to the page on the networking system, or a feature which allows a button to be added to the page on the networking system.

25. The non-transitory computer-readable storage medium of claim 16, wherein the one or more features relate to administration of the page on the networking system.

26. The non-transitory computer-readable storage medium of claim 18, wherein the one or more factors comprise at least one of the page on the networking system amassing a selected number of fans, a picture being added to the page on the networking system, or a post being made to the page on the networking system.
